(19) United States
(12) Patent Application Publication
(10) Pub. No.: US 2014/0156309 A1
(43) Pub. Date: Jun. 5, 2014

(54) METHOD FOR PROVIDING AN UP-TO-DATE ELECTRONIC VITAL MEDICAL INFORMATION RECORD

(71) Applicant: Hassan SANNOUFI, Kanata (CA)

(72) Inventor: Hassan SANNOUFI, Kanata (CA)

(21) Appl. No.: 14/096,353

(22) Filed: Dec. 4, 2013

Related U.S. Application Data
(60) Provisional application No. 61/733,009, filed on Dec. 4, 2012.

(51) Int. Cl. G06F 19/00

(52) U.S. Cl. CPC G06F 19/322
USPC 705/3

(57) ABSTRACT

A method for providing an electronic health record of a patient to a healthcare provider, the method comprising obtaining health information pertaining to the patient assembling an electronic health record comprising the health information pertaining to the patient; storing the electronic health record in an database on a read-writable storage medium; selecting from the health information vital medical information; organizing the vital medical information in a readable-only electronic format to create a vital medical information record; and enabling a healthcare provider or patient to access the vital medical information record via a server or trough a memory storage device.

### RELATED APPLICATION DATA

This application is related to and claims priority to U.S. Provisional Application No. 61/733,009, filed Dec. 4, 2012, entitled “Method for Providing an Up-to-Date Electronic Vital Medical Information Record”, which is expressly incorporated herein by reference in its entirety.

### FIELD

The present invention pertains to a system and method for providing an up-to-date electronic health record. More particularly, the present invention pertains to a device for storing and/or accessing vital medical information in a single location.

### BACKGROUND

Providing healthcare providers with accurate medical records of a patient is important in providing the patient with appropriate medical care and treatment. Sometimes, this may not be easy if the patient has visited many different doctors.

Important medical information may be distributed across different doctors and may not be shared with all of the healthcare providers in the healthcare team. Without access to hill and up to date records, a healthcare provider may act without knowledge of important information, which may cause harm to the patient. Accurate, accessible and shareable health information is a prerequisite of effective modern healthcare.

Electronic health records are commonly stored in databases managed by healthcare providers. The centralizing of patient health information from a plurality of healthcare providers is becoming more demanding, at least because data and reports from healthcare providers are generated in a wide variety of formats. Each type of healthcare provider, and sometime each health provider individually, has a preferred report generating system. Sometimes these are electronically generated, such as in text or digitized images, however many remain hand written. Accordingly, assembling a easily accessible electronic patient health record involves converting the multitude of report formats into a single, standardized, readable format that is accessible to all professionals.

U.S. Pat. No. 5,832,488 to Eberhardt discloses a computer system and method for programming data of an individual's entire medical history on a storage device. The program is designed to record information on a smart card, such as patient identifier information and an entire medical history of the patient including pharmaceutical information.

U.S. Pat No. 8,195,479 to Lubell discloses a method of recording, updating and accessing a person's medical history over time includes the steps of maintaining the person's medical history in a portable memory device that includes both the medical history and a program that stores medical records in a secure database in the portable memory device, updates the medical records in the secure database, and provides access to the medical records in the secure database.

U.S. Pat. No. 7,865,735 to Yiachos discloses a computer implemented method for managing a person's medical information including a first tier of medical information made available to a first person upon authentication, a second tier of medical information made available upon authentication the second request. This enables sharing of certain information with appropriate healthcare providers, while maintaining other information inaccessible to the same healthcare provider.

International published PCT application No. WO 2011/028261 discloses a portable, secure medical record storage and management device together with systems and methods for inputting, managing and updating the records contained in such a device. Additionally provided are mobile devices which can provide assistance and relay information in emergency situations. Access to the contents of medical record storage and management device is controlled using biometric sensors as well as other authentication means.

Published United States Patent application No. 2012/0191473 by Severin discloses a portable, hand held or body worn device for storing and presenting personal medical information, so as to establish a comprehensive medical history which can be consulted by medical care providers. The device may comprise a data processing device which can receive, store, organize, and display or transmit medical data.

There remains a need for a standardized system of storing and making accessible the personal and medical information of individual patients to improve the delivery of healthcare of patients. Specifically, there remains a need for enabling healthcare providers to have a full picture of the patient's health history by way of providing an electronic health record which will allow third party access to accurate and up-to-date health records.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

One object of the present invention is to provide the vital and selective medical information from the electronic health record that can change medical decision making or decrease the number of unnecessary tests ordered.

In accordance with one aspect, there is provided a method for providing an electronic health record of a patient to a healthcare provider, the method comprising: obtaining health information pertaining to the patient;

a) assembling an electronic health record comprising the health information pertaining to the patient:

b) storing the electronic health record in an database on a read-writable storage medium;

c) selecting from the health information vital medical information

d) organizing the vital medical information in a readable-only electronic format to create a vital medical information record; and

e) enabling a healthcare provider or patient to access the vital medical information record via a server or through a memory storage device.

In accordance with one embodiment the memory storage device is a universal serial bus (USB) drive, microchip, smartphone or an internet-enabled computing device.

In accordance with another embodiment, the electronic health record is stored in a central read-writable database accessible via a server to the internet.

In accordance with another embodiment, the vital medical information record comprises electronic hyperlinks to health information in the electronic health record.

In accordance with another embodiment, the vital medical information comprises a plurality of health information selected from one or more of blood pressure, blood type, immunization record, medical history, surgical history, blood work results, pulmonary function test, pharmaceutical prescriptions, electrocardiogram and family history.

In accordance with another embodiment, the vital medical information comprises a plurality of personal information selected from one or more of name, date of birth, phone number, address, emergency contact information, marital status, employer, medical insurance information and government identification.

In accordance with another embodiment, the method further comprises providing an electronic alert to the patient and/or healthcare provider. In one embodiment, the electronic alert comprises a drug-drug interaction alert, an alert indicating that the electronic health record has been updated, a medication dosing alert, or an alert to update health information. In another embodiment, the electronic alert is provided via electronic mail, telephone, cellular telephone, text message, secure private message, voice-over internet protocol (VoIP), instant messaging, or satellite communication systems.

In accordance with another aspect, there is provided a method of providing vital medical information of a patient to a healthcare provider, the method comprising:

a) assembling health information pertaining to the patient in an electronic health record;

b) selecting vital medical information from the health information in the electronic health record to create a vital medical information record: and

c) storing the vital medical information in a readable-only format on a memory storage device,

wherein the vital medical information is accessible to the healthcare provider from the memory storage device.

In accordance with one embodiment, the electronic medical record, or parts thereof, is also stored on the memory storage device.

In accordance with another embodiment, the memory storage device is a USB drive, optical disc, solid state this or a microchip.

In accordance with another embodiment, the vital medical information comprises a plurality of health information selected from one or more of blood pressure, blood type immunization record, medical history, surgical history, and family history. In another embodiment, the vital medical information comprises a plurality of personal information selected from one or more of name, date of birth, phone number, address, emergency contact information, marital status, employer, medical insurance information and government identification. In another embodiment, the vital medical information record comprises electronic hyperlinks to health information in the electronic health record.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 depicts a schematic of the flow of health information from the healthcare provider to the device or system;

FIG. 2 depicts a summary of the health information for a subscriber from the vital medical record;

FIG. 3 depicts a summary of the medical and surgical history for a subscriber from the vital medical record;

FIG. 4 depicts a summary of the family history for a subscriber from the vital medical record;

FIG. 5 depicts a summary of the prescribed medications for a subscriber from the vital medical record;

FIG. 6 depicts a summary of the body measurements and vitals for a subscriber from the vital medical record;

FIGS. 7A and 7B depict the front and back, respectively, or an exemplary device in the form of a flash drive; and

FIGS. 8A and 8B depict the front and back, respectively, of an exemplary device in the form of a bracelet charm, with an optionally embedded read-write memory means.

### DETAILED DESCRIPTION OF THE INVENTION

Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

The term “healthcare provider” as used herein, refers to persons or organizations that provide medical services. The healthcare provider can be an individual person such as, but not limited, to a nurse, doctor, dentist, medical or dental technician, pharmacist, physiotherapist, emergency care support worker, paramedic, or fire fighter. The healthcare provider can also be an organization, non-limiting examples of which are hospitals, imaging centers, and diagnostic laboratories.

The term “patient” as used herein, refers to the individual person whose medical records are stored in the electronic health record. It is understood that in a medical situation, the individual is a ‘patient’ when under the care of a healthcare profession. Accordingly, this individual can also be referred to as a “subscriber” to the presently described system and method.

The term “electronic health record” as used herein, refers to the electronic compilation of health information and personal information available for the patient or subscriber. The electronic health record is updated on a regular basis. The electronic health record can be stored on the portable device, or can be accessed by the portable device using executable software.

The term “portable device” as used herein, refers to a device which can store and/or access the electronic health record. It is understood that the portable device is readable/writable device which contains executable software for accessing the electronic health record.

The term “personal information” as used herein, refers to general information in electronic form about the subscriber that is not considered to be medical information. Such information can include but is not limited to name(s), current address, previous addresses, date of birth, emergency contact information, family history, family medical history, emergency contact information, work history and behavioural data such as, for example, alcohol use, tobacco use, sexual habits, diet, and exercise.

The term “medical information” as used herein, refers to medical records in electronic form generated by or provided by healthcare providers. Non-limiting examples of these medical records include medical reports, referral letters, images, medications, genetic tests, immunizations, medical conditions, allergies, surgeries, medical alerts and laboratory results, results of genetic testing, medical history, health history, and the results of one or more clinical examinations.

The term “health information” as used herein, refers to all the information contained in the electronic health record. This consists at least of the personal information, medical information, and vital medical information.

The terms “vital information” and “vital medical information” refers to a subset of the information in the electronic health record which is made available on the device and provided to healthcare providers for rapid assessment of the needs of a patient.

The term “support centre” as used herein, refers to the individual or group of individuals responsible for maintaining the electronic health record for the subscriber. The support centre can also include an emergency contact centre, or the emergency contact centre can be a separate entity contactable by the support centre or the subscriber in the case of emergency.

Presently described is a system and method of recording, updating, and accessing the electronic health record of a patient. The method is carried out by a support centre whose responsibility it is to maintain an up-to-date electronic health record for a patient. Because the responsibility of the updating and maintenance of the electronic health record falls entirely within the auspices of the support centre, the accuracy and reliability of the electronic health record is ensured. Further, the electronic health record provides vital medical information to a healthcare provider when a patient in is an emergency situation, specifically when the patient is unconscious or otherwise incapacitated.

The amount of data in the form of the information in an electronic health record can be voluminous, and only a small fraction of this information is required on an emergency basis to treat a patient. It is the role of the support centre to parse through the electronic health record to identify the vital medical information that can be made available on the device to a healthcare professional when immediate access to this vital information is required.

Vital medical information can be accessed as required by primary healthcare providers, as well as by healthcare providers who may not have immediate access to the patient medical records. Specific, non-limiting occasions where having a portable electronic health record would be useful is during military deployment, when the patient is required to visit multiple specialists, and or for individuals who travel. As the electronic health record and vital medical information contained therein can be easily accessed by the patient or healthcare provider, vital medical information is available on an immediate basis when it is most crucial.

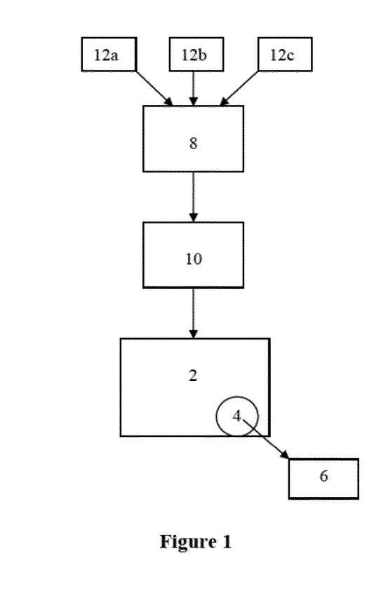

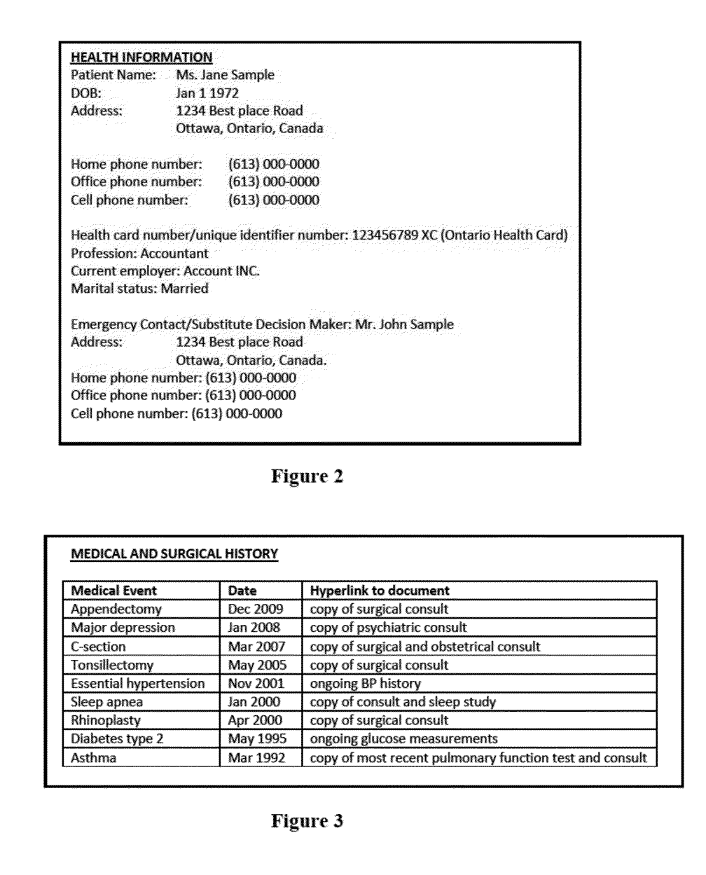

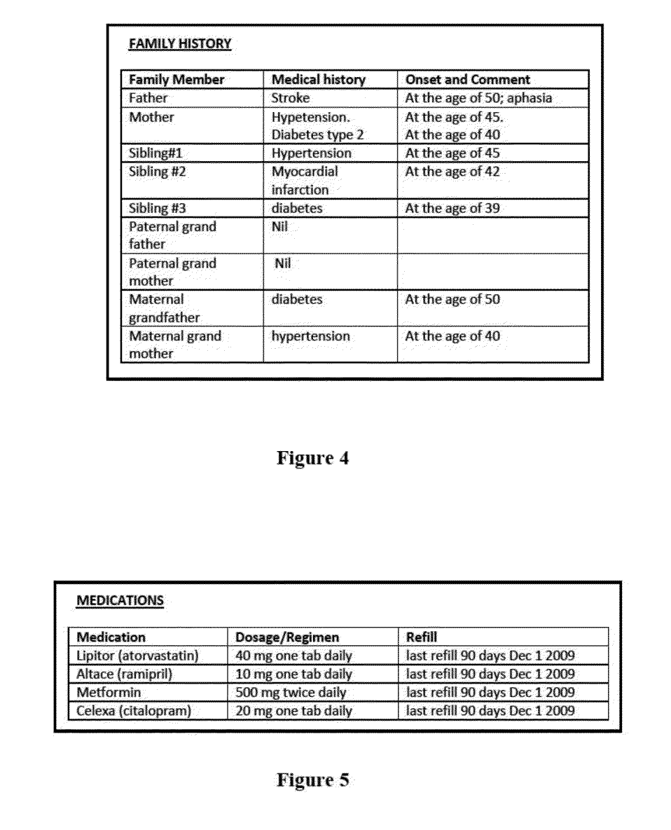

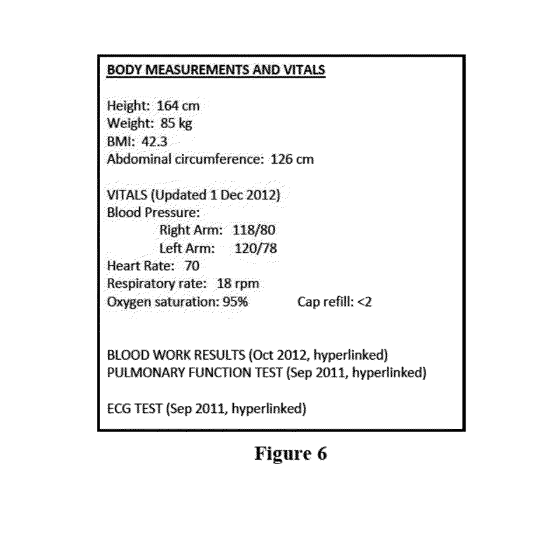

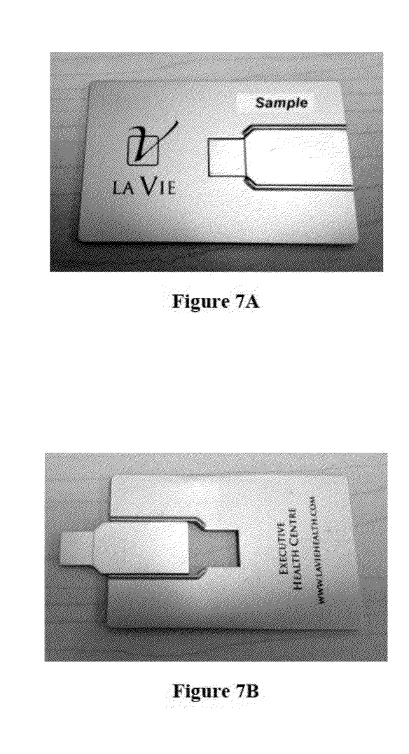

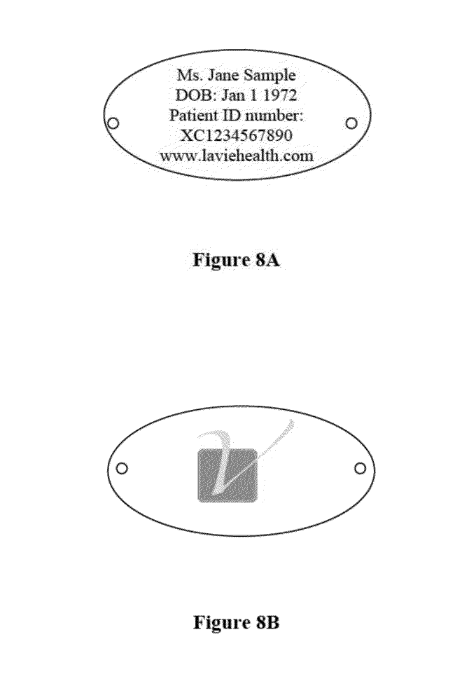

As exemplified in the exemplary health information flow diagram shown in FIG. 1, health information is obtained from a healthcare provider (8) and provided to the support centre (10). The support centre (10) reviews the health information provided by the healthcare provider, and puts the data or electronic files into an indexed record in the electronic health record. The support centre also extracts any updated vital medical information for inclusion in a file for storing the vital medical information for rapid access by a healthcare provider.

The electronic health record is regularly updated by the support centre. The steps of collecting the patient's information, can include, for example, (i) inputting the patient's information into a proprietary electronic form; (ii) storing the completed electronic forms in a private and secure central database; and (iii) storing all or a portion of the completed electronic forms or proprietary summary on a mobile private and secure storage device, such as a USB card. The method can further include storing on the mobile storage device contact information to allow a physician or the patient to contact a person, or the private and secure central database electronically, to obtain additional patient information (that is not stored on the mobile storage device) from the central database and/or to contact the patient's personal physician or clinic.' Over time, this includes the steps of maintaining the person's medical history in a portable memory device that includes both the medical history and a program that stores medical, personal, and vital medical information (health information) in a secure database in the portable memory device, updates the health information in the secure database, and provides access to the up-to-date electronic medical record from the secure database.

The present system and method provides access to updated medical information that can be critical to healthcare providers to provide subscribers the most appropriate care.

The medical information on the device or on the smart phone is regularly updated and screened exclusively by the support centre. The support centre will ensure all healthcare providers and the subscriber have the required medical information.

Electronic Health Record

Various types of personal information can be stored on the device including, but not hunted to name(s), current address, previous addresses, date of birth emergency contact information, family history, family medical history, emergency contact information, work history and behavioural data such as, for example, alcohol use, tobacco use, sexual habits, diet, and exercise.

Various types of medical information can be stored in the electronic health record including, but not limited to medical reports, referral letters, images, medications, genetic tests, immunizations, medical conditions, allergies, surgeries, medical alerts and laboratory results. Other medical information can include results of genetic testing, medical history, health history, the results of one or more clinical examinations. Some examples of laboratory results include but are not limited to pathologic, hematologic, radiologic, cinematic, outpatient diagnostic tests, among others.

Vital medical information can be critical to make appropriate medical decisions by comparing the baseline with current values. Preferably, every subscriber should have specific and up to date vital medical information that a healthcare provider may require in order to be aware of the health of the patient. This vital medical information can include, but is not limited to ECG, baseline blood work and baseline imaging studies or screening tests that are relevant to are and gender, it is understood that the term ‘up-to-date’ as it refers to this vital medical information is relative to the type of medical information.

Information stored in the electronic health record can be obtained from a variety of healthcare providers, such as, for example, primary healthcare providers, specialists, laboratories, nursing agencies, dentists, and the like.

The information can be provided in a variety of formats. These formats include but are not limited to hardcopy, electronic or paper records including handwritten notes, transcribed notes, diagnostic tests, photographs, X-rays, and lab results. Other sources of health information can include medical or personal information, as discussed above. Vital medical information will be extracted by the support centre from the information provided by a healthcare provider, and the electronic health record will be updated accordingly. The support centre can also attend to filing and optionally indexing the added information provided by the healthcare provider into the electronic health record.

To provide an easily readable overview of the electronic health record, selective vital medical information rather than whole medical information that can be in certain situations very hard to screen through. This selective vital medical information is screened by a team of healthcare professionals that can accurately determine which of the medical information should be in the electronic health record, and assess the importance of the medical information. In this way, a variable hierarchy, responsibility and accessibility to medical information can be established within the electronic health record. To accomplish this, the medical information is reviewed by support centre and selected and classified based on priority.

Device

Information in the electronic health record contained on the device can be synchronized via the internet in real time via, connection to an internet-enabled computer or device. Alternatively, when the device is an internet-enabled or data communication device, the This ensures that the

The portable device comprises as machine-readable and machine writable memory. The electronic health record can be stored on the device itself or can stored externally and be accessible by the device through machine-executable software. Specifically, the portable device comprises an electronic storage medium wherein health information can be accessed, stored and/or updated. The device further contains software comprising machine-executable software which enables access to the memory on the device and/or access to the externally stored electronic health record.

In one embodiment, the portable device is a read-write memory storage device. Non-limiting examples of memory storage devices are smart cards, compact flash cards, secure digital (SD) cards, mini SD cards, micro SD cards, multi-media cards, memory sticks, portable flash memory based universal serial bus (USB) drives, micro drives, magnetoresistive random-access memory (MRAM), ferroelectric random-access memory (FRAM), and static random-access memory (SRAM). The memory storage device is a non-volatile memory.

In another embodiment, the portable device can be a dedicated device for carrying out the described methods. In another embodiment, the portable device can be an application (app) installed on a multifunctional device. The electronic health record can then be either stored on the portable device, or stored externally to the device but accessible via locally stored machine-executable software. Non-limiting examples of multifunctional device includes, but is not limited to mobile phones, smartphones, MP3 players, handheld computers, personal digital assistants (PDAs) tablets, laptop computers, and wearable electronic devices.

The portable device can also connect to a computer or the internet through known techniques, such as through a cable or wirelessly. In this way, the portable electronic device can allow healthcare providers to obtain near instant access to important and medically relevant information.

The device is a unique medical storage unit that can be visible or easily accessible to health care provider if patient is unconscious and requires immediate care when there is no time to look into internet access. However, the vital medical information and electronic health record can also be accessed via the internet with subscriber identification number and appropriate security.

Health information and vital medical information in the electronic health record is regularly updated but the support centre, and can be synchronized to the portable device via a proprietary or publicly available file transfer system or internet connected mechanism or device.

The portable device can also be encrypted to ensure that the personal and medical information stored therein is accessible only to the healthcare provider who is providing service to the subscriber, and the subscriber themselves. In addition, the device can be configured to required authentication to access the electronic health record, to create a response to requester with information in the electronic health record, to transfer personal health related information from the electronic health record to report generating or storage devices; and to communicate with the support centre via a network.

The device may also include a tracker, for example a GPS locator or other similar locating mechanism. In such embodiment, the GPS coordinates for the location of the device can be relayed in the case of an emergency. In some embodiments, the location of the device will be sent automatically upon activation of the emergency signal. In other embodiments, the user may choose to send their location, when they activate the emergency signal. In other embodiments, the device may be located using cell tower triangulation.

The portable device can also include a body function monitor which can monitor functions such as respiration, heart rate, physical activity, blood pressure, blood sugar, body temperature or any other type of body function known to be monitorable by a portable device.

The device can be registered to a particular subscriber. Alternatively, the device can be enabled to access the electronic health records of more than one subscriber, such as in the case of a family, wherein the device is in the possession of the responsible person, such as an adult responsible for the healthcare of an elderly parent, or a parent responsible for the healthcare of a child.

Executable software can be installed in the portable device and provides access to the electronic health record. In the case where the portable device is a memory storage device, the medical record can be accessed after being electronically connected to the input of a reading device such as, for example, a computer. The electronic connection can be carried out by any method known to the skilled person, non-limiting examples of which include a USB port or data transfer cable. The electronic health record stored on the device can be accessed either locally by establishing an electronic communication with a computer, or alternatively by other computers via an authenticated request.

Support Centre

The support centre is integral for maintaining and updating the health information in each electronic health record. The support centre comprises and individual or group of individuals with expertise in medical information management. Preferably, the health information contained in the electronic health record will be entirely maintained and updated by the support centre.

To ensure the credibility and accuracy of the health information in the electronic health record, it is preferable that the subscriber and healthcare providers not have access to modifying or updating the content of the medical information. To ensure that all medical and personal information stored therein is correct, updating and adding to the electronic medical record is preferably done by the support centre. In this way, the health information contained therein is accurate, and up to date.

The support centre is preferably available to provide service and support to the subscriber on a 24/7 basis to ensure that healthcare professionals have access to the patient records at the time that they need them. The support centre can also be available for providing support for accessing the portable device in the case that healthcare providers require technical assistance. This is especially important in the case of an emergency to the patient, when obtaining medical records quickly can contribute to the speed at which treatment can be provided, thus improving the prognosis for the patient.

The addition of medical information/personal information to the electronic health record is controlled by the support centre. A flowchart of the system of the process of medical information acquisition, collection, organization, and access is shown in FIG. 1. The patient signs a consent form to release medical information to the support centre upon subscribing. The support centre then receives, collects, or seeks out new medical information to be added to the electronic health record. This can be accomplished by soliciting medical information from healthcare providers known to be servicing a patient, or by being provided with medical information from the healthcare provider or the patient.

There are several way of identifying if a patient has been provided with medical care by a healthcare provider. In one embodiment, the device can have a tracking system via navigation that can identify the attendance of a patient at a medical or healthcare facility. Once the support center has been alerted, an email can be sent to patient, or patient can be called to verify if the patient has in fact visited the facility after which the support center will contact the medical facility to request the medical information. The patient can also be advised to notify the support center for any visit to a health care facility so we can obtain the medical information. Preferably, a signed consent form copy is electronically made available to the healthcare provider to alerting the healthcare provider to fax a copy of the patient medical information to the support center. In this way, the new medical information can be promptly added to the electronic health record.

Once the medical information is received from the healthcare provider, it is screened by the support centre, and based on a specific criteria the information either get filed into EHR or get sent to a health care professional for review, initially gets reviewed by RN and if necessary get reviewed by MD for further recommendation. Once information is reviewed, a decision will be made if the information is medically necessary or vital medical information. If the decision is made that the information is vital medical information, it will be stored into the vital medical information section of the electronic health record, which will be uploaded into the device when the device is synchronized. The electronic health record and the vital medical information content can be accessed on-line as well by using special FOB and user ID and password.

Security

Access to the electronic medical record stored in the portable device can be further controlled by electronic encryption. The executable software can also allow encryption to allow the portable device to share the electronic health record with a healthcare provider. The portable electronic, device can also comprise protocols for encrypting and storing personal record data, transferring the electronic health record or parts thereof to a healthcare provider, and for communicating with the support centre.

In one embodiment, security can be provided by requiring a security key, password, or a digital security key stored in a Web server. These can be provided alone, or in combination to provide additional security in order to gain access to the electronic health record.

In addition, various levels of access can be granted, based on the desires of the subscriber, and the requirements of the healthcare provider. Specifically, certain information may be assigned with a higher or lower accessibility depending on the privacy desired by the subscriber, the necessity to share certain information with certain healthcare providers, and the type of healthcare provider desiring of information about the subscriber. In one example, a physiotherapist would be able to provide :superior care if provided with radiologic results of a recent fracture, however would not require access to family medical history or current prescriptions.

Alerts and Protocols

In the case where the portable electronic device is communication enabled, the portable device can also include additional alerts and/or protocols to communicate with healthcare providers to provide information to the subscriber or contact with first responders in the case of emergency. These alert protocols can provide an alert for communication with the subscriber and/or healthcare providers. This communication can be via any known electronic communication system including, but not limited to electronic mail, telephone, cellular telephone, text message, secure private message, voice-over internet protocol (VoIP), instant messaging, other messaging systems, and satellite communication systems.

Cheek-In and Emergency Protocols

One alert protocol can include as check-in system to medical facilities. Specifically, if the subscriber requires attention from a healthcare provider, the portable electronic device an alert protocol can be activated to locate a nearby healthcare provider and preferably provide details of the location of the nearby healthcare provider to the subscriber. In one example, the location of the subscriber is determined through a satellite navigation system. Once the location of the subscriber is be identified, and the subscriber will receive a communication from the support centre to verify that the subscriber requires medical attention. Replying positively to the communication will put the subscriber into contact with the identified healthcare provider. Another protocol can relay with local emergency departments to check for wait times and/or medical specialties to direct the subscriber to the most appropriate emergency clinic. In another protocol, the electronic health record of the subscriber can be provided to the healthcare provider so that the healthcare provider can be made fully aware of the medical history of the subscriber.

Another protocol can include an emergency system to alert a first responder should the subscriber require immediate medical attention. Specifically, in the case of an emergency, the portable electronic device can communicate with the support centre to alert the centre to the impending, emergency. Such an emergency can include, for example, a situation wherein the subscriber is incapacitated.

Pharmacy Protocols

Another protocol that can be incorporated into the executable software is an alert for drug-drug interaction. There are various electronic applications, databases, and libraries available that can be engaged to review the prescriptions of the subscriber and ensure that there are no drug-drug interactions. If a new medication is prescribed to the subscriber, the electronic health record will be updated. This update can execute a protocol that will check the currently prescribed drugs for any drug-to-drug interactions. Preferably, if a drug-drug interaction is detected by the protocol, the subscriber and/or healthcare provider would be alerted so that the healthcare provider can take appropriate action.

Another protocol that can be setup for the device is an alert for the subscriber that it is time to take a particular medication. The time between doses of medications varies between every few hours to once every few months. Accordingly, it is understandable that for patients taking multiple medications, remembering which medications to take and when can sometimes result in error. This becomes increasingly difficult with the number of medications a patient is taking. Further, for patients whose memory is impaired, having such an alert can assist with increasing their independence.

This protocol can alert a subscriber which medication to take, how much to take, and when. If the device has a display screen, an image of the correct medication and amount thereof (such as the number of tablets, capsules, or doses) can be displayed on the screen to further remind the patient. This alert can also request the subscriber to enter that the medication was taken, and will register in the electronic health file once the subscriber indicates that it was taken. This can be done, for example, by providing an electronic button that the subscriber can push to positively indicate that the medication was taken. Further, collecting the data on the adherence of tire patient to the pharmaceutical regimen can also serve as important medical information for healthcare providers.

A further protocol can include a subscriber feedback protocol that can accept inputs into the portable device from the subscriber. Such a protocol may include, for example, a brief questionnaire for the subscriber which may present a question and various options for the subscriber to answer. In one example, if the subscriber is in persistent pain and a healthcare provider is attempting to treat the pain, alerting the subscriber to answer a questionnaire regarding his current level of pain can be invaluable for correlating the occurrence with pain with other factors in the patient's life, such as, for example, the pharmaceutical regimen. Alternatively, the subscriber feedback protocol can include text-based inputs from the subscriber to allow for each subscriber to document health information in his own electronic health record.

Electronic Health Record Update Protocol

When new medical information is added to the electronic health record, the subscriber and/or any healthcare provider who requires this information for providing care to the subscriber can also be alerted. The subscriber can be alerted by way of any electronic communication known to the skilled person, and described above. Alternatively, the executable software on the device can be configured to alert the subscriber to an update by providing, for example, a visual, auditory, or vibrational alert. This update protocol can be further configured to only provide alerts under certain circumstances, for example when new medical information has been added, such as a laboratory test or critical result.

Another update protocol can be provided to a healthcare provider to indicate that the vital medical information of the subscriber is out of date and requires updating. In this way, ongoing medical and/or preventative services can be provided to the subscriber in a timely way. Some non-limiting examples of vital medical information that requires updating are results from an electrocardiogram, mammogram, blood pressure test, liver enzyme test, hemoglobin level, white blood cell count, hormone level, and pap smear.

All publications, patents and patent applications mentioned in this Specification are indicative of the level of skill of those skilled in the art to which this invention pertains and are herein incorporated by reference to the same extent as if each individual publication, patent, or patent application was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A method for providing an electronic health record of a patient to a healthcare provider the method comprising:
a) obtaining health information pertaining to the patient;
b) assembling an electronic health record comprising the health information pertaining to the patient;
c) storing the electronic health record in an database on a read-writable storage medium;
d) selecting from the health information vital medical information;
e) organizing the vital medical information in a readable-only electronic format to create a vital medical information record; and
f) enabling a healthcare provider or patient to access the vital medical information record via a server or through a memory storage device.

2. The method of claim 1, wherein the memory storage device is a universal serial bus (USB) drive, microchip, smartphone or an internet-enabled computing device.

3. The method of claim 1, wherein the electronic health record is stored in a central read-writable database accessible via a server to the internet.

4. The method of claim 1, wherein the vital medical information record comprises: electronic hyperlinks to health information in the electronic health record.

5. The method of claim 1, wherein the vital medical information comprises a plurality of health information selected from one or more of blood pressure, blood type, immunization record, medical history, surgical history, blood work results, pulmonary function test, pharmaceutical prescriptions, electrocardiogram and family history.

6. The method of claim 1, wherein the vital medical information comprises a plurality of personal information selected from one or more of name, date of birth, phone number, address, emergency contact information, marital status, employer, medical insurance information and government identification.

7. The method of claim 1, further comprising providing an electronic alert to the patient and/or healthcare provider.

8. The method of claim 7, wherein the electronic alert comprises a drug-drug interaction alert, an alert indicating that the electronic health record has been updated, a medication dosing alert or an alert to update health information.

9. The method of claim 7, wherein the electronic alert is provided via electronic mail, telephone, cellular telephone, text message, secure private message, voice-over internet protocol (VoIP), instant messaging, or satellite communication systems.

10. A method of providing vital medical information of a patient to a healthcare provider the method comprising:
a) assembling health information pertaining to the patient in an electronic health record;
b) selecting vital medical information from the health information in the electronic health record to create a vital medical information record; and
c) storing the vital medical information in a readable-only format on a memory storage device,
wherein the vital medical information is accessible to the healthcare provider from the memory storage device.

11. The method of claim 10, wherein the electronic medical record, or parts thereof is also stored on the memory storage device.

12. The method of claim 10, wherein the memory storage device is a USB drive, optical disc, solid state drive, or a microchip.

13. The method of claim 10, wherein the vital medical information comprises a plurality of health information selected from one or more of blood pressure, blood type, immunization record, medical history, surgical history, and family history.

14. The method of claim 10, wherein the vital medical information comprises a plurality of personal information selected from one or more of name, date of birth, phone number, address, emergency contact information, marital status, employer, medical insurance information and government identification.

15. The method of claim 10, wherein the vital medical information record comprises electronic hyperlinks to health information in the electronic health record.
